(19) United States
(12) Patent Application Publication
(10) Pub. No.: US 2022/0383256 A1
(43) Pub. Date: Dec. 1, 2022

(54) POST-VEHICULAR INCIDENT RECONSTRUCTION REPORT

(71) Applicant: Microsoft Technology Licensing, LLC, Redmond, WA (US)

(72) Inventors: Soo Jung ROH, Mountain View, CA (US); Rahul Anantha Padmanabha UDIPI, Cupertino, CA (US); Benjamin Charles CHAN, Aliso Viejo, CA (US)

(21) Appl. No.: 17/331,607

(22) Filed: May 26, 2021

(51) Int. Cl. G06Q 10/10; G06F 16/93

(52) U.S. Cl. CPC G06Q 10/10; G06F 16/93

(57) ABSTRACT

The disclosure herein describes systems and methods for generating a post-vehicular incident report. In some examples, the system includes receiving a notification from a user device indicating the user device has been involved in an incident, obtaining incident data from the user device that includes a timestamp and location data, retrieving third-party incident data corresponding to the timestamp and the location data received in the incident data, generating a timeline of the incident based on the obtained incident data from the user device and the retrieved third-party incident data, the generated timeline including events occurring prior to the incident and events occurring after the incident, generating a report of the incident based on the generated timeline, the obtained incident data, and the retrieved third-party incident data, the report including the timeline, and outputting the generated report to the user device and at least one of a plurality of approved devices.

### BACKGROUND

Following a vehicular incident, reconstructing a sequence of events leading up to and following the incident can be challenging. Most reconstruction is based on the testimony and recall of a person who was in or witnessed the incident. However, it is well-known and understood that the testimony and recall of a person can be unreliable, which leads to difficulties reconstructing the sequence of events. Current solutions can identify that an incident occurred but fail to provide information regarding events leading up to the incident and information regarding how the aftermath of the incident was handled.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized system and method for generating a post-vehicular incident reconstruction report is provided. The system includes a processor and a computer-readable medium. The computer-readable medium stores instructions that, upon execution by the processor, cause the processor to receive a notification from a user device indicating the user device has been involved in an incident, responsive to receiving the notification from the user device, obtain incident data from the user device, the incident data including a timestamp and location data, responsive to obtaining the incident data, retrieve third-party incident data corresponding to the timestamp and the location data received in the incident data, generate a timeline of the incident based on the obtained incident data from the user device and the retrieved third-party incident data, the generated timeline including events occurring prior to the incident and events occurring after the incident, generate a report of the incident based on the generated timeline, the obtained incident data, and the retrieved third-party incident data, the report including the timeline, and output the generated report to the user device and at least one of a plurality of approved devices.

Other examples provide a computer-implemented method for generating a post-vehicular incident reconstruct report. The computer-implemented method includes receiving a notification from a user device indicating the user device has been involved in an incident, responsive to receiving the notification from the user device, obtaining incident data from the user device, the incident data including a timestamp and location data, responsive to obtaining the incident data, retrieving third-party incident data corresponding to the timestamp and the location data received in the incident data, generating a timeline of the incident based on the obtained incident data from the user device and the retrieved third-party incident data, the generated timeline including events occurring prior to the incident and events occurring after the incident, generating a report of the incident based on the generated timeline, the obtained incident data, and the retrieved third-party incident data, the report including the timeline, and outputting the generated report to the user device and at least one of a plurality of approved devices.

Still other examples provide one or more computer-readable storage media for generating a post-vehicular incident reconstruction report comprising a plurality of instructions that, when executed by a processor, cause the processor to receive a notification from a user device indicating the user device has been involved in an incident, responsive to receiving the notification from the user device, obtain incident data from the user device, the incident data including a timestamp and location data, responsive to obtaining the incident data, retrieve third-party incident data corresponding to the timestamp and the location data received in the incident data, generate a timeline of the incident based on the obtained incident data from the user device and the retrieved third-party incident data, the generated timeline including events occurring prior to the incident and events occurring after the incident, generate a report of the incident based on the generated timeline, the obtained incident data, and the retrieved third-party incident data, the report including the timeline, and output the generated report to the user device and at least one of a plurality of approved devices.

### BRIEF DESCRIPTION OF THE DRAWINGS

The present description will be better understood from the following detailed description read in light of the accompanying drawings, wherein:

FIG. 1 is a block diagram illustrating a system for generating a post-vehicular incident reconstruction report according to an example;

FIG. 2 is a block diagram illustrating data flow for generating a post-vehicular incident reconstruction report according to an example;

FIGS. 3A and 3B are a flowchart illustrating a computer-implemented method of generating a post-vehicular incident reconstruction report according to an example;

FIG. 4 is a flowchart illustrating a computer-implemented method of generating a timeline of an incident according to an example;

FIG. 5 is a flowchart illustrating a computer-implemented method of generating a post-vehicular incident reconstruction report according to an example;

FIG. 6 is a block diagram illustrating an example computing environment suitable for implementing one or more of the various examples disclosed herein.

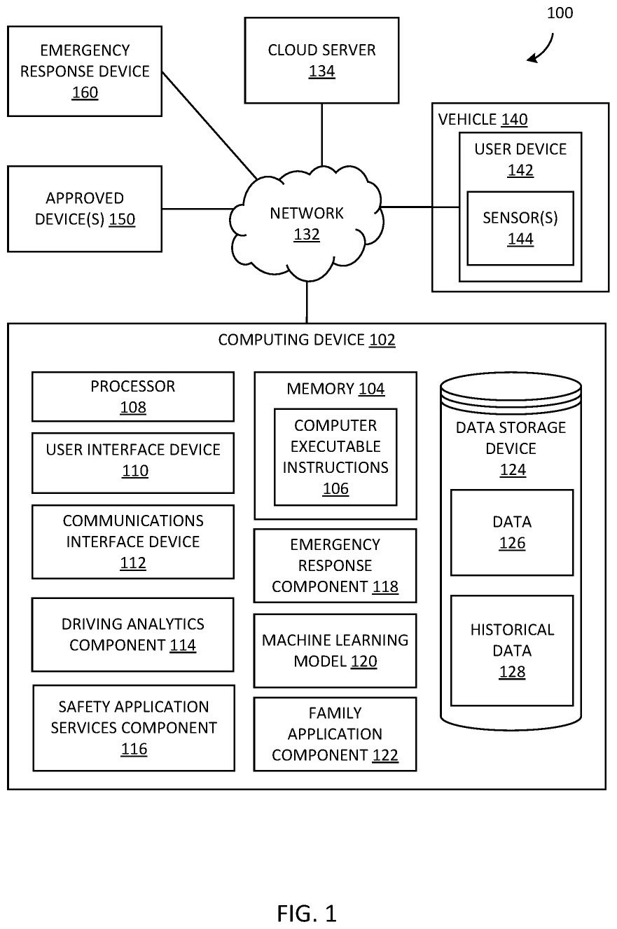

Corresponding reference characters indicate corresponding parts throughout the drawings. In FIGS. 1 to 6, the systems are illustrated as schematic drawings. The drawings may not be to scale.

### DETAILED DESCRIPTION

Aspects of the disclosure provide a computerized method and system for generating a post-vehicular incident reconstruction report that includes a timeline of events leading up to and following the incident. The method and system includes obtaining incident data from a user device regarding the incident, retrieving various third-party data regarding the incident, converting the obtained and retrieved data into a standardized, textual format, generating a timeline using the standardized data, generating a report based on the generated timeline, and outputting the generated report to authorized devices. Accordingly, the system provided in the present disclosure operates in an unconventional manner by collecting data regarding an incident from multiple sources, converting the collected data into a standardized format, generating a report based on the data, and outputting the report to authorized devices. The central collection and processing of incident data further protects the privacy of the user of the device by preventing data from being shared between outside, third parties and requiring multiple levels of authorization.

Furthermore, the conventional solutions provided fail to generate accurate incident reconstruction reports due to the reliance on the testimony of persons involved in or witnesses to the incident that are well-documented as unreliable. Current solutions that do attempt to generate reports typically only provide a notification that an incident has occurred, possibly at a particular location, without additional detail that reconstructs the incident including the events leading up to and following the incident.

FIG. 1 is a block diagram illustrating a system for generating a post-vehicular incident reconstruction report according to an example. The system 100 illustrated in FIG. 1 is provided for illustration only. Other examples of the system 100 can be used without departing from the scope of the present disclosure.

The system 100 includes a computing device 102, a network 132, a cloud server 134, and a user device 142. The computing device 102 represents any device executing computer-executable instructions 106 (e.g., as application programs, operating system functionality, or both) to implement the operations and functionality associated with the computing device 102. The computing device 102 in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

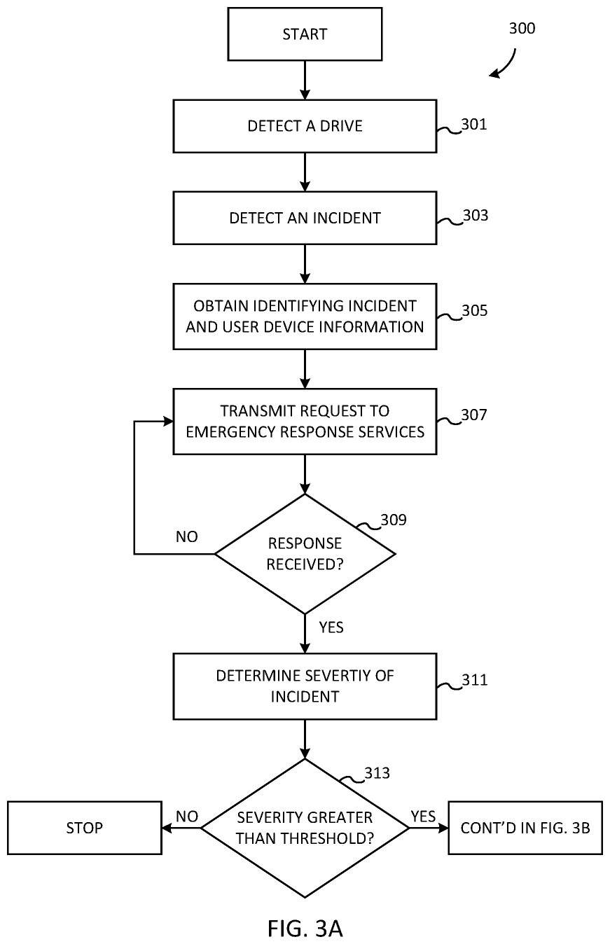

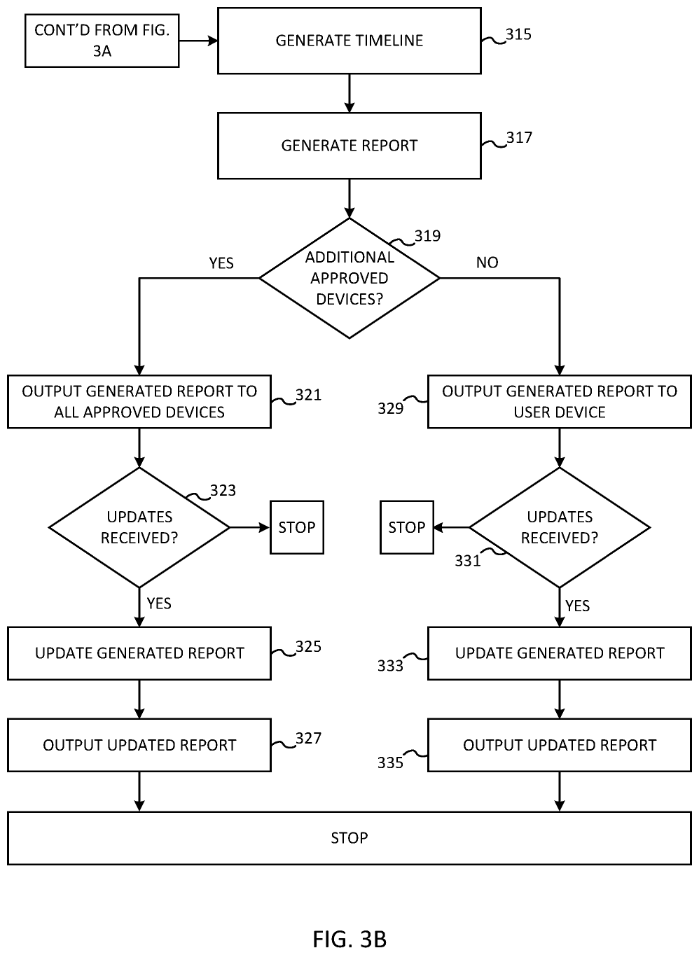

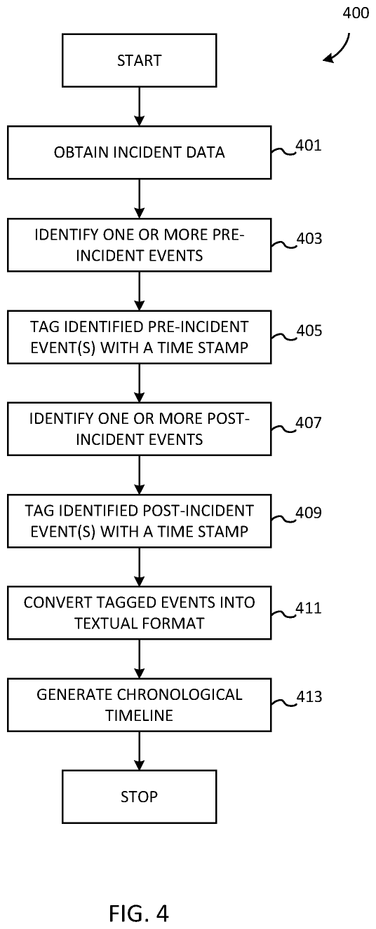

In some examples, the computing device 102 includes at least one processor 108, a memory 104 that includes the computer-executable instructions 106, and a user interface device 110. The processor 108 includes any quantity of processing units and is programmed to execute the computer-executable instructions 106. The computer-executable instructions 106 are performed by the processor 108, performed by multiple processors within the computing device 102, or performed by a processor external to the computing device 102. In some examples, the processor 108 is programmed to execute computer-executable instructions 106 such as those illustrated in the figures described herein, such as FIGS. 3A-3B, 4, and/or 5. In various examples, the processor 108 is configured to execute one or more of the driving analytics component 114, the safety application services component 116, the emergency response component 118, the machine learning model 120, and the family application component 122.

The memory 104 includes any quantity of media associated with or accessible by the computing device 102. In some examples, the memory 104 is internal to the computing device 102. In other examples, the memory 104 is external to the computing device 102 or both internal and external to the computing device 102. For example, the memory 104 can include both a memory component internal to the computing device 102 and a memory component external to the computing device 102. The memory 104 stores data, such as one or more applications. The applications, when executed by the processor 108, operate to perform various functions on the computing device 102. The applications can communicate with counterpart applications or services, such as web services accessible via the network 132. In an example, the applications represent downloaded client-side applications that correspond to server-side services executing in a cloud, such as the cloud server 134.

The user interface device 110 includes a graphics card for displaying data to a user and receiving data from the user. The user interface device 110 can also include computer-executable instructions, for example a driver, for operating the graphics card. Further, the user interface device 110 can include a display, for example a touch screen display or natural user interface, and/or computer-executable instructions, for example a driver, for operating the display. The user interface device 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 102 in one or more ways.

In some examples, the user interface device 110 is configured to launch and display a visualization of the safety application services component 116. For example, the processor 108 can execute the computer-executable instructions 106 stored in the memory 104 to execute the safety application services component 116 to generate the post-incident reconstruction report in response to a trigger event. The generated post-incident reconstruction report is displayed, such as via the user interface device 110.

The computing device 102 further includes a communications interface device 112. The communications interface device 112 includes a network interface card and/or computer-executable instructions, such as a driver, for operating the network interface card. Communication between the computing device 102 and other devices, such as but not limited to the cloud server 134, can occur using any protocol or mechanism over any wired or wireless connection. In some examples, the communications interface device 112 is operable with short range communication technologies such as by using near-field communication (NFC) tags.

The computing device 102 further includes a data storage device 124 for storing data, such as, but not limited to data 126 and/or historical data 128. The data 126 can be data received from the user device 142 and/or data received, retrieved, or obtained by one or more of the driving analytics component 114, the safety application services component 116, and the emergency response component 118. The historical data 128 can be data, such as driving analytics, from previous drives that is compared to newly received driving data, such as the data 126. In some examples, differences in data 126 for a particular drive that includes an incident and the historical data 128 from previous, similar drives can be identified by the driving analytics component 114 for inclusion in the generated incident report described in greater detail below. The data storage device 124 can include one or more different types of data storage devices, such as, for example, one or more rotating disks drives, one or more solid state drives (SSDs), and/or any other type of data storage device. The data storage device 124 in some non-limiting examples includes a redundant array of independent disks (RAID) array. In other examples, the data storage device 124 includes a database.

The data storage device 124, in this example, is included within the computing device 102, attached to the computing device 102, plugged into the computing device 102, or otherwise associated with the computing device 102. In other examples, the data storage device 124 includes a remote data storage accessed by the computing device 102 via the network 132, such as a remote data storage device, a data storage in a remote data center, or a cloud storage.

The driving analytics component 114 captures and processes driving analytics. In some examples, the driving analytics component 114 obtains and/or receives driving data from the user device 142 as the user device 142 moves in association with a vehicle 140. In other words, the user device 142 can capture driving-related data, such as speed of the user device 142, location of the user device 142, usage of the user device 142, and so forth, that is then obtained, analyzed, and stored by the driving analytics component 114. For example, the driving analytics component 114 obtains data from the user device 142 that includes a timestamp, location identifying information, sensor data, and other application data from the user device, and uses the obtained data to determine that at a particular point in time, the location of the user device 142 is on a highway, the speed of the user device 142 is 65 miles per hour (MPH), and the user device 142 is executing a map application with directions that include the highway location on the way to a destination. Based on the obtained data, the driving analytics component 114 determines the user device 142 is in a vehicle, such as the vehicle 140, on the highway traveling at 65 MPH on the way to the destination on the map application.

In some examples, the driving analytics component 114 detects an incident based on the driving data obtained from the user device 142. As applied to the example above, the user device 142 is determined to be in a vehicle, such as the vehicle 140, on the highway traveling at 65 MPH on the way to a destination indicated on the map application. In the example of an incident, the speed of the user device 142 suddenly and abruptly changes from 65 MPH to 0 MPH and the location data remains relatively constant for a period of time. In some examples, the driving analytics component 114 interprets the sudden change in speed to 0 MPH, in combination with the constant location on the highway, with a potential incident. An incident may include, without limitation, traffic, impact, collision, braking, accelerating, swerving, spinning, turning, loss of pressure, change in altitude, or any number of vehicle-related scenarios.

The safety application services component 116 monitors the safety of a user of one or more user devices 142. For example, an application can be installed on the user device 142 that communicates with the safety application services component 116. The safety application services component 116 transmits and receives data to and from, respectively, various other elements in the system 100 as described in greater detail below. In various examples, the safety application services component 116 transmits and receives data to and from, respectively, one or more of the user device 142, the driving analytics component 114, the emergency response component 118, the machine learning model 120, the family application component 122, the cloud server 134, and one or more approved devices 150. In some examples, responsive to an incident being detected and the data being received from one or more of the user device 142, the driving analytics component 114, the emergency response component 118, the machine learning model 120, and the family application component 122, the safety application services component 116 generates a post-vehicular incident reconstruction report.

The emergency response component 118 transmits and receives data to and from, respectively, the safety application services component 116 and an emergency response device 160. The emergency response device 160 is a third-party data source that aggregates emergency response data regarding the incident. For example, the emergency response device can be one or more servers, databases, computers, or any suitable device that collects information regarding the incident from emergency responders, such as police departments and/or fire departments, and sends the information to the computing device 102 for analysis and inclusion in the generated report. In some examples, the emergency response data includes, but is not limited to, information regarding whether an emergency response was initiated, a transcript of an emergency call, such as a 911 call, a recording of the emergency call, whether air bags were deployed in the vehicle 140 involved in the incident, a route emergency responders took to the location of the incident, a time at which the emergency responders arrived at the location of the incident, and so forth.

In some examples, responsive to the driving analytics component 114 detecting the incident, the emergency response component 118 transmits a notification to the emergency response device 160 to inform of the incident. As described in greater detail below, the notification includes identifying information about the incident and can also include, but is not limited to, one or more of a request for an emergency response, information regarding the severity of the incident, and so forth. The emergency response component 118 receives a response from the emergency response device 160, which is then transmitted to the safety application services component 116. In some examples, the emergency response component 118 further receives updated data from the emergency response device 160 at a later time after the incident has been responded to by emergency services and transmits the updated data to the safety application services component 116.

The machine learning (ML) model 120 learns the driving habits of a user of the user device 142. The ML model 120 is trained based on continuously added new data received from the driving analytics component 114 to identify driving habits of a user of the user device 142. For example, the ML model 120 can be trained to identify driving habits of the user that include, but are not limited to, one or more of a particular route that is taken from home to work or from home to school, speed habits such as whether the user drives at or below the speed limit, drives above the speed limit, and if so by how much, whether the user device 142 is regularly used while the user is driving the vehicle 140, how the driving habits change in different types of weather or at different times of day, and so forth. Once the ML model 120 identifies driving habits of the user of the user device 142, this information can be used to make the post-vehicular incident reconstruction report generated by the safety application services component 116 more robust. In some examples, the ML model 120 includes, but is not limited to, a neural network, a statistical ML model, and so forth.

The family application component 122 receives data from the safety application services component 116, such as the post-vehicular incident reconstruction report generated for an incident in which a member of a family was involved. In some examples, the family application component 122 transmits and receives data to and from, respectively, a corresponding application installed at an electronic device such as the user device 142 and/or one or more approved devices 150. The family application component 122 can push the post-vehicular incident reconstruction report to the corresponding application of the user device 142 and the one or more approved devices 150.

As described herein, the vehicle 140 is a machine used to transport people or goods from one location to another. Various examples of the vehicle include, but are not limited to, motor- or electric-powered vehicles such as a car, a sport utility vehicle (SUV), a pickup truck, a van, a truck, a bus, or a motorcycle. In various examples, the vehicle can further include, but is not limited to, a bicycle, a drone, a train, a boat, a scooter, a cart, and so forth.

As described herein, the one or more approved devices 150 are additional devices that have been approved to receive the post-vehicular incident reconstruction report of an incident involving the user device 142. In some examples, a single account, such as a family account, includes more than one device, such as the user device 142 and additional devices. In examples where an additional device is approved or has opted in, the additional device is categorized as an approved device 150. In some examples, approved devices 150 are not limited only to devices included on the same plan and can include other devices that have been invited to be approved by one or more of the user device 142 or another approved device 150.

In some examples, the user device 142 includes one or more sensors 130. The sensors 130 can include, but are not limited to, an accelerometer, a global positioning system (GPS), an odometer, and any other suitable sensor for a mobile computing device. The sensors 130 measure the speed, position, location, and/or movement of the user device 142. In some examples, the sensor data is used to identify speed and/or movement of the user device 142 based on data collected by the sensors 130. In some examples, as described in greater detail below, the sensor data obtained from sensors 130 is used to identify a drive event based on the sensor data indicating acceleration and/or motion of the user device 142 above a threshold speed. The threshold speed enables the systems disclosed herein to distinguish between movement of the user device 142 by a person in an automobile or other transportation vehicle, and movement of the user device 142 by a person moving on foot, i.e., moving but not in an automobile.

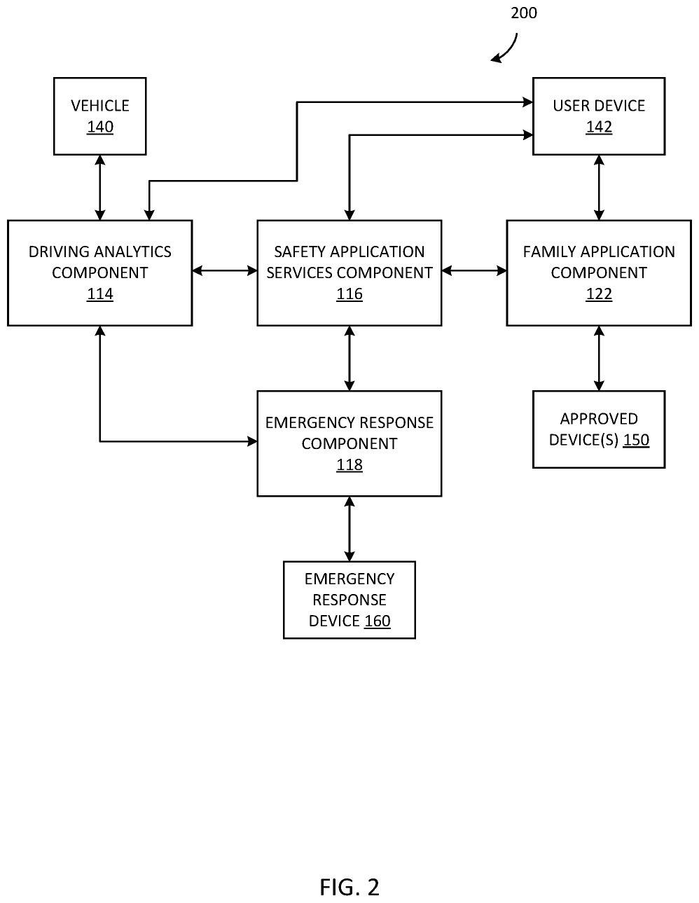

FIG. 2 is a block diagram illustrating data flow for generating a post-vehicular incident reconstruction report according to an example. The block diagram 200 is for illustration only and should not be construed as limiting. Other examples of the block diagram 200 can be used without departing from the scope of the present disclosure.

As shown in FIG. 2, data flow for generating the post-vehicular incident reconstruction report includes the driving analytics component 114, the safety application services component 116, the emergency response component 118, and the family application component 122. As described herein, the driving analytics component 114 captures and processes driving analytics using data obtained from the user device 142. In some examples, the driving analytics component 114 further obtains data from the vehicle 140 to capture and process driving analytics instead of or in addition to the data obtained from the user device 142. The data captured by the user device 142 includes, but is not limited to, one or more of speed of the user device 142, location of the user device 142, and usage of the user device 142. In some examples, the driving analytics component 114 uses the location data of the user device 142 to obtain additional data including, but not limited to, one or more of a speed limit at the location, weather at the location, traffic at the location, and so forth. In other examples, the user device 142 uses the location data to obtain the additional data. The data obtained from the vehicle 140 can include but is not limited to, one or more of speed of the vehicle 140, location of the vehicle 140, the state of various applications executed by the vehicle 140 such as the radio, the maps, etc., whether seat belts are buckled inside the vehicle 140, and so forth.

In some examples, the driving analytics component 114 analyzes the obtained data in real-time as the data is obtained. For example, where the data indicates the user device 142 is located in a residential or commercial area and is substantially still or moving intermittently and at a minimal speed, the driving analytics component 114 does not identify the user device 142 as in a driving state. In some examples, the driving analytics component 114 identifies the user device 142 as in a driving state responsive to the user device 142 connecting, such as via Bluetooth™, to the vehicle 140, responsive to identifying the user device 142 is at a location indicated as a road and moving at a speed that meets or exceeds a threshold speed, responsive to the user device 142 executing a map application, and so forth. The threshold speed can be set by a user or predetermined, such as a speed of 5 MPH or 10 MPH.

In other examples, the data is analyzed by the user device 142 in real-time as the data is obtained and then transmitted to the driving analytics component 114. In other words, the user device 142 analyzes the data in real-time to identify a speed, location, speed limit at the location, and so forth of the user device 142 and transmits the data to the driving analytics component 114.

For example, data obtained from the vehicle 140 can indicate only the driver's seat belt is buckled, the map application is being executed with a destination identified as work, and the radio is set to a particular station at a “low” volume. Data obtained from one or more of the vehicle 140 and the user device 142 indicates the speed and location of the one or more of the vehicle 140 and the user device 142.

In some examples, the driving analytics component 114 analyzes the obtained data to obtain additional information, such as the speed limit and weather at the location of the one or more of the vehicle 140 and the user device 142. Accordingly, the driving analytics component 114 detects a drive is in progress and, in real-time, monitors and analyzes the additional data obtained in real-time. In other examples, the user device 142 receives, from the vehicle 140, the data obtained by the vehicle 140 and detects a drive is in progress and, in real-time, monitors and analyzes the additional data obtained in real-time. In other words, the user device 142 analyzes the obtained data to obtain additional information, such as the speed limit and weather at the location of the one or more of the vehicle 140 and the user device 142 and detects the drive is in progress and, in real-time, monitors and analyzes the additional data obtained in real-time. In some examples, the user device 142 transmits the analyzed data to the driving analytics component 114. In some examples, the user device 142 transmits a result of the analyzed data to the driving analytics component 114, such as a notification of a potential incident as described in greater detail below.

In some examples, the analyzed data indicates a potential incident involving the user device 142. As referenced herein, an incident refers to any type of collision, contact, or near-collision identified between the vehicle 140 and another object. The other object referenced herein can include, but is not limited to, one or more of another vehicle, a road sign, a pedestrian, a stationary object proximate to a road on which the vehicle is traveling, and so forth. In some examples, an incident includes the vehicle 140 traveling off of the road into areas that are not identified as suitable for a vehicle 140, such as a median. As discussed herein, the potential incident can be indicated by a sudden and abrupt change from a traveling speed to 0 MPH and constant location, by data indicating contact with an object from one or more sensors 130 on or in the vehicle 140, by detecting a notification from the vehicle 140 indicating deployment of the airbags of the vehicle 140, and so forth. Responsive to the analyzed data indicating the potential incident, the user device 142 transmits a notification of the potential incident to the driving analytics component 114.

Responsive to the driving analytics component 114 receiving the notification of the potential incident from the user device 142, the safety application services component 116 obtains incident data from the user device 142. The incident data includes, but is not limited to, one or more of a location of the user device 142, a timestamp of the incident that identifies a time at which the incident occurred, a speed of the user device 142 prior to the incident, a speed of the user device 142 immediately following the incident, a speed limit at the location of the user device 142, a status of a user of the user device 142 after the incident, or a usage state of the user device 142 prior to the incident. The status of the user of the user device 142 after the incident includes health-related information of the user. In some examples, the health-related information of the user is collected via an external device, including but not limited to a wearable device, a heartrate monitor, a blood pressure monitor, or any other device suitable for collecting health-related information and transmitting the health-information to one or more of the user device 142 and the computing device 102. In some examples, the health-related information is collected via a user input received by the user device 142 in response to a prompt to the user requesting health information. For example, the prompt can include asking the user to provide an input regarding whether they are hurt and, if so, to describe their injuries. The usage state of the user device 142 refers to whether the user device 142 was in use at the time of or immediately preceding the incident. For example, the usage state is determined to be “in use” where the user device 142 was executing an application, such as a web browser or a messaging application, at the time of or immediately preceding the incident.

Responsive to the driving analytics component 114 receiving the notification of the potential incident from the user device 142, the safety application services component 116 further identifies a unique identifier corresponding to the user device 142. The unique identifier identifies the particular user device 142 and is used by the safety application services component 116 to obtain additional information regarding the potential incident. In some examples, the unique identifier is a phone number associated with the user device 142. In some examples, the unique identifier is a serial number of the user device 142. In some examples, the unique identifier is a device identifier, or PUID, that is accessible to owners of the safety application services component 116.

The safety application services component 116 uses the unique identifier of the user device 142 to confirm the user device 142 is opted-in to a report generation feature. The safety application services component 116 confirms the user device 142 is opted in by cross referencing the unique identifier against a database storing the unique identifier of opted in devices. After confirming the user device 142 is opted-in to the report generation feature, the retrieval of third-party incident data is triggered. Third-party incident data is emergency response data regarding the incident received from the emergency response device 160, rather than the user device 142 involved in the incident. Third-party incident data includes, but is not limited to, one or more of information regarding whether an emergency response was initiated, whether air bags were identified as deployed in the vehicle 140 involved in the incident by emergency responders, a route emergency responders took to the location of the incident, a time at which the emergency responders arrived at the location of the incident, and details from an emergency response call. In some examples, the third-party incident data includes data received from emergency response services including policy departments and fire departments, national weather reporting services, local news services reporting traffic data, and so forth.

In some examples, the third-party incident data regarding the emergency response is given particular weight. The information regarding whether the emergency response was initiated includes whether an emergency alert was initiated and if so, who initiated the emergency response. In particular, an emergency alert, such as a 911 call, is commonly initiated by any one of the user of the user device 142, a witness to the incident, a passenger in the vehicle 140 involved in the incident, another party that was involved in the incident, a contact of the user whom the user informed about the incident using the user device 142, and so forth. As described herein, the emergency alert is the indication sent to an emergency dispatch, such as a 911 call, and the emergency response data is the data collected by an emergency response team that responds to the incident based on the emergency alert. The information regarding the route emergency responders took to the location can include the navigation to scene of the incident, the amount of time between the emergency responders receiving the call about the incident until arrival, details regarding any emergency alarms or sirens that were activated in route, and so forth. In various examples, the information regarding details from the emergency alert can include a transcript of the emergency alert, a recording of the emergency alert, a summary of the emergency alert that includes the details shared regarding the incident, and so forth.

To retrieve the third-party incident data, responsive to confirming the user device 142 is opted-in to the report generation feature, the emergency response component 118 transmits a request to the emergency response device 160 for the emergency response data. The request for the third-party incident data includes the unique identifier for the user device 142, the timestamp in the obtained incident data, and the location data in the obtained data. The unique identifier, timestamp, and location data are used by the emergency response device 160 to authenticate the particular request and to identify the particular third-party incident data requested. For example, a request for incident data at a particular time at a particular location is more likely to provide sufficient detail for the correct incident data to be provided than a request for incident data without one or more of a timestamp or location. Particularly in densely populated urban areas, a request for incident data at one of a particular time or a particular location may not be specific enough to yield data regarding the particular incident because more than one incident can occur at or around the same time in different areas of an area or at the same location but in different times or on different days.

As described above, the emergency response device 160 can be an electronic device or devices that stores emergency response information obtained from first responders such as police departments, fire departments, and so forth. The emergency response information can be stored in a database or in multiple databases either on the emergency response device 160 or accessible by the emergency response device 160. Responsive to the emergency response device 160 authenticating the request received from the emergency response component 118, the emergency response device 160 transmits the emergency response information, i.e., the third-party incident data, to the emergency response component 118.

Responsive to receiving both the incident data from the user device 142 and the third-party incident data from the emergency response device 160, the safety application services component 116 generates a timeline of the incident. The timeline includes events occurring prior to the incident and events occurring after the incident. For example, the generated timeline includes events including, but not limited to, a time the vehicle 140 was turned on, whether a navigation application to a particular location was executed by the user device 142 at the time of the incident, a history of the particular drive that included the incident, incident details, usage of the user device 142, details regarding an emergency response call, if any, and details regarding the emergency response to the incident, if applicable. The history of the particular drive includes timestamps at regular intervals, such as every second, five seconds, ten seconds, twenty seconds, and so forth corresponding to a location of the user device 142 and/or the vehicle 140. The timestamps and location data are used to create a log of the drive of the user device 142 and/or the vehicle 140 that illustrates the route taken by the user device 142 and/or the vehicle 140 and includes a time of each position along the route, speed at each time and position, and so forth. In some examples, the log of the drive is overlaid with usage data of the user device 142 to identify whether the user device 142 was being used during the drive, at what time the user device 142 was used during the drive, and at which location at the particular time the user device 142 was used during the drive. In some examples, the log of the drive is overlaid with the navigation data to identify whether a driver of the vehicle 140 followed the navigation instructions to the particular location and, if the navigation instructions were deviated from, to identify at which point the driver of the vehicle deviated from the navigation instructions. Generating the timeline is described in greater detail below in the description of FIG. 4.

The safety application services component 116 generates a report of the incident based at least on the generated timeline, the obtained incident data, and the retrieved third-party incident data. The report of the incident includes one or more of text and images to describe the events leading up to the incident, the incident, and the events following the incident. In some examples, the generated report is a generated as a single file, including but not limited to a .docx file, a .pdf file, or a .ppt file. In other examples, the generated report is a detailed interactive timeline that includes a timeline of the events and selectable options for obtaining additional detail regarding at least some of the events.

The family application component 122 outputs the generated report to one or more devices, such as the user device 142 and the approved devices 150. In some examples, the generated report is output to the user device 142 and at least one approved device 150 in addition to the user device 142. In some examples, the generated report is output by sending the report via electronic mail or SMS messaging to a phone number or email address associated with users of the approved devices. In some examples, the generated report is output by pushing the report to the device via an application installed on the device.

In some examples, the safety application services component 116 receives additional detail regarding the incident after the generated report is output by the family application component 122. For example, the generated report can be referred to as an initial generated report that includes preliminary details of the incident such as the events leading up to the incident and details regarding the incident. Additional or updated information can be received, such as from the emergency response device 160 or other devices, that can include, but is not limited to, details regarding a route taken by emergency services to the location of the incident, the condition of one or more persons involved in the incident, the condition of one or more vehicles involved in the incident, identified causes of the incident as determined by emergency services, such as first responders, data received from the user device 142 regarding the incident, whether air bags were deployed in the vehicle 140 involved in the incident, a time at which the emergency responders arrived at the location of the incident, and details from an emergency response call.

As described herein, the safety application services component 116 is connected to the vehicle 140 and can receive data regarding whether air bags were deployed in the vehicle 140 involved in the incident, such as via a wireless communication transmission. In some examples, data regarding whether the air bags were deployed is received from the vehicle 140 itself, such as a device implemented on the vehicle 140. In some examples, data regarding whether the air bags were deployed is detected based on sensor or noise measurements in the user device 142. In some examples, data regarding whether the air bags were deployed is detected based on an input from the user to the user device 142 when asked to provide information regarding the incident. In some examples, data regarding whether the air bags were deployed is included in the third-party incident data received from the emergency response device 160.

Based on receiving additional detail regarding the incident, the safety application services component 116 updates the initial generated report to include the additional detail. In some examples, the updated report includes the information included in the initial report and the additional detail. In some examples, the additional received detail clarifies detail included in the initial generated report. In other words, the initial generated report includes information that, based on the information available at the time of the generation of the initial generated report, appears to be true but cannot be confirmed, and is confirmed by the additional detail received. For example, the initial generated report can include detail indicating the incident appears to be of a certain severity level, which is confirmed in the additional detail received based on further information collected by emergency services or provided by a user of the user device 142.

Based on the initial generated report being updated, the family application component 122 outputs the updated report to the one or more devices, such as the user device 142 and the approved devices 150, as described herein.

FIGS. 3A and 3B are a flowchart illustrating a computer-implemented method of generating a post-vehicular incident reconstruction report according to an example. The computer-implemented method 300 is presented for illustration only and should not be construed as limiting. Other examples of the computer-implemented method 300 can be used without departing from the scope of the present disclosure. The computer-implemented method 300 can be implemented by one or more electronic devices described herein, such as the computing device 102. FIG. 3B is a continuation of the computer-implemented method 300 illustrated in FIG. 3A.

The method 300 begins by the computing device 102 detecting a drive-in operation 301. In some examples, the computing device 102 detects a drive based on the user device 142 connecting to the vehicle 140. The user device 142 can connect to the vehicle 140 via a wireless connection, such as via Bluetooth™, or via a wired connection, such as via a USB connection, a USB-C connection, or any other suitable wired connection. In some examples, the computing device 102 detects a drive based on the user device 142 executing a map application that includes navigation to a location. In some examples, the computing device 102 detects a drive based on a speed of the user device 142 being above a certain threshold, such as above ten MPH. In some examples, the computing device 102 detects a drive based on detecting acceleration or motion of the user device 142. The computing device 102 identifies the acceleration or motion based on feedback received from a sensor, such as the sensor 130. For example, the sensor 130 identifies the motion and the computing device 102 recognizes the motion as a drive based on the acceleration and/or motion being above a threshold speed. For example, the computing device 102 can recognize the motion as a drive when a velocity of the user device 142 meets or exceeds a threshold velocity, such as a velocity of 10 miles per hour (MPH) for example. In other examples, the user device 142 recognizes the motion as a drive and transmits a notification of the driving state to the computing device 102.

In operation 303, the computing device 102 detects a potential incident. In some examples, based on the drive being detected, the user device 142 is identified as being in a drive mode. In the drive mode, certain behaviors of the user device 142 are anticipated, such as high speeds, variable speeds, changes in location over short times, and so forth. On the other hand, certain behaviors are not anticipated or are otherwise flagged as potential incident behaviors, such as suddenly changing from a high rate of speed to zero MPH. Accordingly, unanticipated behavior such as a sudden change from the high rate of speed to zero MPH is flagged or detected as a potential incident. In some examples, a potential incident is detected by a user of the user device 142 manually reporting an incident, such as via an application installed on the user device 142 corresponding to the family application component 122, by the user device 142 accessing a portal page on a web browser, and so forth. In some examples, the computing device 102 detects the potential incident based on the incident being manually reported, such as by a user of the user device 142.

In operation 305, the computing device 102 obtains identifying incident data and user device information. The obtained incident data includes, but is not limited to, one or more of a speed of the user device prior to the incident, a speed of the user device immediately following the incident, a speed limit at the location of the user device, a status of a user of the user device after the incident, and a usage state of the user device prior to the incident. The user device information includes identifying information of the user device 142, such as a unique identifier. As described herein, the unique identifier identifies the particular user device 142 and can be a phone number associated with the user device 142 or a serial number of the user device 142.

In some examples, obtaining the incident information includes receiving input data from a user to the user device 142. For example, upon detection of the incident, the user device 142 can display a prompt that requests an input from the user regarding their status. In some examples, the input can be a selection of one of multiple options, such as “OK”, “Need Assistance”, “No Incident”, “Not OK”, and so forth. In some examples, the input can be a textual message input by a user via a keyboard or touch screen on the user device 142. In some examples, the input can be a textualized version of a spoken input, such as via a speech-to-text feature of the user device 142. In some examples, the input is an input received on the user device 142. For example, the input can be an input of a phone number corresponding to a number requesting assistance, such as a personal contact or a widely known emergency number such as “911”.

In some examples, the computing device 102 confirms the user device 142 is opted-in to a report generation feature using the unique identifier. In some examples, the computing device 102 confirms the user device 142 is opted in by cross referencing the unique identifier against a database storing the unique identifier of opted in devices. After confirming the user device 142 is opted-in to the report generation feature, the computing device 102 triggers the retrieval of third-party incident data.

To retrieve the third-party incident data, in operation 307, the computing device 102 transmits a request to emergency response services, such as the emergency response device 160, for third-party incident data. The transmitted request includes the unique identifier, the timestamp in the incident data obtained from the user device 142, and the location data in the incident data. In other words, the computing device 102 transmits a request for particular emergency response data at a particular time and particular location that can be tied to a particular device at the scene of the incident. As described herein, the unique identifier, timestamp, and location data can be used by the emergency response device 160 to authenticate the particular request and to identify the particular third-party incident data requested. As described herein, the data is information from the incident that is received from a third-party. The third-party incident data that is requested includes, but is not limited to, one or more of information regarding whether an emergency response was initiated, whether air bags were deployed in the vehicle 140 involved in the incident, a route emergency responders took to the location of the incident, a time at which the emergency responders arrived at the location of the incident, and details from an emergency response call.

In operation 309, the computing device 102 determines whether a response to the request for the third-party incident data has been obtained. If a response has not been received within a threshold amount of time, the request is re-transmitted to the emergency response services. If a response is received, the computing device 102 proceeds to operation 311.

In operation 311 the computing device 102 analyzes the obtained incident data from the user device 142 and the received third-party incident data to determine the severity of the incident. In some examples, the severity of the incident is determined by comparing a last measured speed of the vehicle 140 to a threshold. For example, if the last measured speed was above a threshold speed, such as 75 MPH, before the incident, the incident can be determined to be of a greater severity than if the last measured speed was not above the threshold. In another example, the severity of the incident is determined based on a reception, or lack or reception, of a user input in response to a prompt. For example, if the user device 142 fails to receive a response to a prompt requesting the user to provide information regarding their physical state, the computing device 102 can determine the incident may be severe enough that the user is not able, either physically or mentally, to react to the prompt. Accordingly, the computing device 102 can determine the severity of the incident to be of a greater severity than if the prompt was received.

In operation 313, the computing device 102 determines whether the severity of the incident is greater than, i.e., above, a threshold. In some examples, the threshold is a numerical score identifying the severity of the incident, above which is significant enough to warrant the generation of a report and below which is not significant enough to warrant the generation of the report. For example, the severity of the incident is measured by a severity index of zero to 100, where zero indicates no severity and 100 indicates the most severity. In this example, the threshold for generating a report can be lower, such as a five, or higher, such as twenty. The threshold can be set to a default level or can be manually set by a user of the user device 142 or one of the approved devices 150. In other examples, the threshold indicates a binary yes or no identification. For example, the threshold can indicate a binary threshold of whether the vehicle 140 containing the user device 142 contacted an external object. A yes indicates a severity above the threshold whereas a no indicates a severity below the threshold. In examples where the severity of the incident is not determined to be greater than the threshold, the method 300 concludes. In examples where the severity of the incident is determined to be above the threshold, the computing device 102 proceeds to operation 315.

In operation 315, responsive to the incident being identified as above the threshold, the computing device 102 generates a timeline of the incident based on the obtained incident data from the user device and the retrieved third-party incident data. The generated timeline including events occurring prior to the incident and events occurring after the incident. The generation of the timeline is described in greater detail below in the description of FIG. 4.

In operation 317, the computing device 102 generates a report of the incident based on the generated timeline, the obtained incident data, and the retrieved third-party incident data. In some examples, the generated report includes the generated timeline generated in operation 315. In some examples, the generated report includes each event included in the generated timeline. In other examples, the generated report includes some, but not all, of the events included in the generated timeline. For example, some of the events can be determined to be immaterial to the incident and are therefore left out of the generated report. As discussed in greater detail below, in some examples the generated timeline includes more than one drive in a trip and each turn made in each drive. In generating the report, the computing device 102 identifies that some events are significant enough to include, such as when and where a drive in the trip concluded, but not necessarily each turn in the drive.

For example, the user device 142 can travel in the vehicle 140 on a long-distance trip that includes both highways and non-highway roads. Where the incident is determined to have happened on a highway, the incident report can focus on the timeline regarding the highway portion of the drive rather than everything occurring on the non-highway roads. In contrast, where the incident is determined to have happened on a non-highway road, the incident report can focus on the timeline regarding the non-highway portion of the drive rather than the portion occurring on the highway roads.

In some examples, generating the report includes transforming data from time and corresponding location data to the generated timeline in addition to a textual format further detailing the drive. Furthermore, the format is standardized to focus on the drive that was recorded up until the point an incident was detected. For example, generating the report includes identifying the pertinent information regarding the drive that is to be included in the report and the information regarding the drive that is unrelated to the incident. In other words, the computing device 102 identifies and tags the portions of the generated timeline to be included in the report and focuses the report on the tagged portions. By focusing the report on particular tagged portions of the timeline, the computing device 102 identifies particular events, for example including but not limited to phone use, hard breaks, rapid acceleration, and so forth, that occurred on the drive that included the incident.

In some examples, the generated report includes a comparison of the driving activity detected by the user device 142 to historical driving data that has been detected by the corresponding application on the user device 142, such as driving instances that did not result in an incident. For example, historical driving activity can indicate that the particular drive in which the incident was detected is a drive that is regularly detected, such as a drive from a home to work of the user of the user device 142. The historical driving activity can include data on historical iterations of the drive, including, but not limited to, weather data, speed data, timestamp data, and so forth.

In one example, the historical driving data can indicate the user device 142 travels at a similar speed regardless of the historical weather data. This can indicate the user of the user device 142 does not slow down, even in driving conditions that are poor. In addition, the obtained incident data from the user device 142 indicates that weather conditions during the incident were rainy and overcast. The computing device 102 analyzes the obtained incident data and the historical data and concludes, or infers, that based on the driving history of the user of the user device 142, excessive speed coupled with the rainy and overcast conditions are a possible contributing factor to the incident. In this example, the generated report includes the conclusion, or inference, that the excessive speed coupled with the rainy and overcast conditions are a possible contributing factor to the incident.

In some examples, the inferences can be further used to include a prompt in the generated report indicating suggestions to reduce the likelihood of an incident being repeated. In the example above where the inference is made that the excessive speed coupled with the rainy and overcast conditions are a possible contributing factor to the incident, the prompt can display a suggestion to avoid excessive speed in the future, particularly in rainy and overcast conditions.

In some examples, the generated report includes a timestamp indicating when the user of the user device 142 marked themselves safe following the incident. As discussed above, once a potential incident is detected, the user device 142 displays a prompt for the user requesting an input from the user regarding their status, which is then transmitted to and received by the computing device 102. The input includes the timestamp, which is included in the generated report. In some examples, the computing device 102 is programmed to anticipate receiving the input, and corresponding timestamp, by a period of time following the initial receipt of the incident. In some examples, the period of time is set at a default time, such as ten seconds, twenty seconds, thirty seconds, and so forth. In some examples, the period of time is set by a user of the user device 142 or a user of one of the approved devices 150. Whether the input is received within the period of time is used as a consideration for determining the severity of the incident. For example, where the input from the user of the user device 142 is received within the period of time, the severity can be inferred to potentially be less severe due to the user appearing to have the mental faculties following the incident to respond. In contrast, where the input from the user of the user device 142 is not received within the period of time, the severity can be inferred to potentially be more severe due to the user potentially not having the mental faculties following the incident to respond. The result of the inference is included in the generated report.

In operation 319, the computing device 102 determines whether approved devices, in addition to the user device 142, are opted in to enable the receipt of the generated report. Approved devices opted in to receive the generated report include the approved devices 150. In some examples, the approved devices 150 are additional devices included on a same account as the user device 142. For example, a family sharing account can include multiple devices in a single family, such as the devices used by parents and the devices used by children. Where the user device 142 is the device utilized by a child, the devices utilized by the parents can be opted in as approved devices 150 but a device utilized by another child is not opted in as an approved device 150. Where the user device 142 is the device utilized by a parent, the devices utilized by the other parent can be opted in as an approved device 150 but the devices utilized by the children are not opted in as an approved device 150. In other words, a device on the account can be opted in as approved devices 150 for some devices and not opted in for other devices. If additional approved devices are determined to be opted in, the computing device 102 proceeds to operation 321. If additional approved devices are not determined to be opted in, the computing device 102 proceeds to operation 329.

In operation 321, responsive to identifying approved devices 150 in addition to the user device 142, the computing device 102 outputs the generated report to all the identified approved devices. For example, the computing device 102 outputs the generated report to the user device 142 and the approved devices 150. In some examples, the generated report is output to each of the identified approved devices by sending the report to a phone number or email address associated with each device. In some examples, the generated report is output to each of the identified approved devices by pushing the report to the device via an application installed on the device.

In operation 323, the computing device 102 determines whether updates, such as updated incident data from one or both of the user device 142 and the emergency response device 160, are available. In some examples, it may take time for the emergency response device 160 to collect and/or process data from the incident, resulting in some incident data not being immediately present to be included in the initial generated report. However, examples of the disclosure take into account that the time sensitive nature of incident reporting and recognize that in some instances, providing limited information quickly after an incident occurs can be advantageous compared to waiting until all information is available before providing a report. For example, in instances where an incident reaches a severity threshold to obtain third-party incident data from emergency services, a preliminary report notifying opted-in devices of the incident while also indicating the safety of the persons involved can be advantageous as opposed to waiting hours or days to inform the opted-in devices of the incident, which could put the safety at risk of the persons involved in the incident.

In some examples, operation 323 is performed multiple times, such as at regular intervals over a period of time. For example, the computing device 102 can check for updates one day after outputting the initial generated report, one week after outputting the initial generated report, and one month after outputting the initial generated report. In some examples, the computing device 102 checks for updates at each interval even after receiving an update to determine if multiple rounds of updates are present. For example, it may take time for the emergency response device 160 to collect and/or process data from the incident, resulting in some incident data not being immediately present and/or taking longer to process. Accordingly, in one particular example, the computing device 102 receives updated incident data one day after outputting the initial generated report and then executes operation 323 to determine whether additional updates may be received.

If updates are not received in operation 323, the method 300 terminates. If updates are received at operation 323, the computing device 102 continues to operation 325. In operation 325, the computing device 102 updates the initial generated report with the updated incident data received at operation 323. For example, where the updated information includes new information that was not available when the initial generated report was generated and output, updating the generated report includes adding the newly received information to the report. Where the updated information includes new information that contradicts or provides additional description to details contained in the initial generated report, updating the generated report includes replacing the previous information and/or supplementing the previous information with the new information.

It should be appreciated that elements of the initial generated report can be maintained in the updated generated report. For example, in some instances the received updates include only information about events following the incident, such as details regarding the emergency response to the incident, the portions of the initial generated report that describe the incident and events leading up to the incident are unchanged in the updated report. In other examples, the updated generated report can include only the updated portions. For example, as described above where the received updates include only information about events following the incident, the updated generated report does not include the previously included information regarding the incident and the events leading up to the incident and only includes the updated information regarding the events following the incident.

In operation 327, the computing device 102 outputs the updated report. For example, the computing device 102 outputs the updated generated report to the user device 142 and the approved devices 150. In some examples, the generated report is output to each of the identified approved devices by sending the report to a phone number or email address associated with each device. In some examples, the generated report is output to each of the identified approved devices by pushing the report to the device via an application installed on the device. Following the updated report being output, the method 300 terminates.

In operation 329, responsive to not identifying approved devices 150 in addition to the user device 142, the computing device 102 outputs the generated report to the user device 142. For example, the computing device 102 outputs the generated report to the user device 142. In some examples, the generated report is output to the user device 142 by sending the report to a phone number or email address associated with each device. In some examples, the generated report is output to the user device 142 by pushing the report to the device via an application installed on the device.

In operation 331, the computing device 102 determines whether updates, such as updated incident data from one or both of the user device 142 and the emergency response device 160, are available. As discussed above, in some examples, it may take time for the emergency response device 160 to collect and/or process data from the incident, resulting in some incident data not being immediately present to be included in the initial generated report. However, examples of the disclosure take into account that the time sensitive nature of incident reporting and recognize that in some instances, providing limited information quickly after an incident occurs can be advantageous compared to waiting until all information is available before providing a report. For example, in instances where an incident reaches a severity threshold to obtain third-party incident data from emergency services, a preliminary report notifying opted-in devices of the incident while also indicating the safety of the persons involved can be advantageous as opposed to waiting hours or days to inform the opted-in devices of the incident, which could put the safety at risk of the persons involved in the incident.

In some examples, operation 331 is performed multiple times, such as at regular intervals over a period of time. As discussed above, the computing device 102 can check for updates one day after outputting the initial generated report, one week after outputting the initial generated report, and one month after outputting the initial generated report. In some examples, the computing device 102 checks for updates at each interval even after receiving an update to determine if multiple rounds of updates are present. For example, it may take time for the emergency response device 160 to collect and/or process data from the incident, resulting in some incident data not being immediately present and/or taking longer to process. Accordingly, in one particular example, the computing device 102 receives updated incident data one day after outputting the initial generated report and then executes operation 311 to determine whether additional updates may be received.

If updates are not received in operation 331, the method 300 terminates. If updates are received at operation 331, the computing device 102 continues to operation 333. In operation 333, the computing device 102 updates the initial generated report with the updated incident data received at operation 331. For example, where the updated information includes new information that was not available when the initial generated report was generated and output, updating the generated report includes adding the newly received information to the report. Where the updated information includes new information that contradicts or provides additional description to details contained in the initial generated report, updating the generated report includes replacing the previous information and/or supplementing the previous information with the new information.

As discussed above, in some examples, elements of the initial generated report can be maintained in the updated generated report. For example, in some instances the received updates include only information about events following the incident, such as details regarding the emergency response to the incident, the portions of the initial generated report that describe the incident and events leading up to the incident are unchanged in the updated report. In other examples, the updated generated report can include only the updated portions. For example, as described above where the received updates include only information about events following the incident, the updated generated report does not include the previously included information regarding the incident and the events leading up to the incident and only includes the updated information regarding the events following the incident.

In operation 335, the computing device 102 outputs the updated report. For example, the computing device 102 outputs the updated generated report to the user device 142. In some examples, the generated report is output to the user device 142 by sending the report to a phone number or email address associated with each device. In some examples, the generated report is output to the user device 142 by pushing the report to the device via an application installed on the device. Following the updated report being output, the method 300 terminates.

FIG. 4 is a flowchart illustrating a computer-implemented method of generating a timeline of an incident according to an example. The computer-implemented method 400 is presented for illustration only and should not be construed as limiting. Other examples of the computer-implemented method 400 can be used without departing from the scope of the present disclosure. The computer-implemented method 400 can be implemented by one or more electronic devices described herein, such as the computing device 102.

The method 400 begins by obtaining the incident data from the user device 142 in operation 401. The obtained incident data is obtained from the user device 142 and includes, but is not limited to, one or more of a speed of the user device 142 prior to the incident, a speed of the user device 142 immediately following the incident, a speed limit at the location of the user device 142, a status of a user of the user device 142 after the incident, a usage state of the user device 142 prior to the incident, a history of the trip that includes the incident, weather data for the trip that includes the incident, the input from the user to the user device 142 following the incident, and so forth. The history of the trip includes all related information about the particular trip in which the incident occurred.

In some examples, a trip can be considered to include a drive, or drives, on which the vehicle 140 leaves a home location and then returns. For example, the trip includes a single drive, i.e., when the vehicle 140 is turned on to when the vehicle 140 is turned off. An example of a trip including a single drive is where the user of the user device 142 turns the vehicle 140 on at home, drives to one or more locations, such as to run errands, pick up kids from school, order a meal at a drive-thru in a restaurant, and so forth, and returns home without turning off the vehicle. The drive includes the time from when the user turns on the vehicle 140 to when the vehicle 140 is turned off and in this example, the trip of leaving home to returning home includes just one drive.

In other examples, the trip includes more than one drive, i.e., the vehicle 140 is turned on and off more than one before the trip is considered to be concluded. An example of a trip including more than one drive is where the user of the user device 142 turns the vehicle on at home, drives to work, and turns the vehicle off at work to conclude a first drive and, in the second drive, the user turns the vehicle on at work, drives home, and turns the vehicle off at home. In this example, the trip includes the time between when the user turns on the vehicle 140 at home to when the user turns off the vehicle 140 at home, but includes more than one drive in the trip.

Examples of the present disclosure recognize and take into account that data regarding a single drive may not always be sufficient to generate the timeline and additional information can be needed. Accordingly, in some examples the obtained incident data in operation 401 includes the data for an entire trip and not only data for the particular drive. Consider an example where the trip, executed by a new driver, such as a teenager, includes a first drive from home to a friend's house, a second drive from the friend's house to a mall, and a third drive from the mall back to the friend's house during which the incident is detected. In this example, data from the entire trip is preferable to include details regarding the passenger that may be in the vehicle following the first drive to the friend's house. If only the information regarding the third drive is included in the obtained data, the picture of the incident may be incomplete. However, by including all the drives in the trip that include the possibility of a friend joining the vehicle 140 as a passenger, the computing device 102 can include in the timeline and the generated report that due to the stopping point of the first drive, other passengers may have been in the vehicle 140 at the time of the incident and contributed to distractions for the user.

In operation 403, the computing device 102 identifies one or more pre-incident events. Pre-incident events are identified as events that occurred prior to the occurrence of the incident. In the example above, each time the vehicle 140 is turned on and turned off is considered an event. In some examples, navigation data, such as each turn made during the drive, is included in the identified events. Other examples of identified events include any instances of usage of the user device 142, instances of sudden increases or decreases in speed, instances where the speed of the user device 142 exceeds the speed limit, a particular application being executed on the user device 142, and so forth. Examples of a particular application being executed can include standard applications, such as a phone or messaging application, or third-party applications such as social media or gaming applications. The execution of an application can be included in the generated report and indicate that the user may have been distracted while the drive was in progress.

In operation 405, the computing device 102 tags each identified pre-incident event with a timestamp. Tagging each identified pre-incident event with a timestamp identifies the precise time at which each event occurred. The tagged events are stored in the computing device, for example as data 126 within the data storage device 124.

In operation 407, the computing device 102 identifies one or more post-incident events. The data including the post-incident events are obtained from one or both of the user device 142 and a third party, such as the emergency response device 160, as the third-party incident data. The post-incident events include, but are not limited to, one or more of whether an emergency response was initiated, whether air bags were deployed in a vehicle involved in the incident, a route emergency responders took to the location of the incident, a time at which the emergency responders arrived at the location of the incident, or details from an emergency response call. As described herein, the post-incident events are identified as corresponding to the event by cross-referencing the timestamp and location of the incident in the request for third-party incident data and comparing to the unique identifier of the user device 142 for further confirmation.

In operation 409, the computing device 102 tags each identified post-incident event with a timestamp. Tagging each identified post-incident event with a timestamp identifies the precise time at which each event occurred. The tagged events are stored in the computing device, for example as data 126 within the data storage device 124.

In operation 411, the computing device 102 converts the tagged events into textual format. As discussed above, the tagged events can be stored as data 126 in the data storage device 124. In order to generate a timeline of the incident including the events leading up to and following the incident, the data 126 is converted into a standard format, such as a text format, that can be arranged chronologically and inserted into a report that can be read by a person when output to the device, such as a user of the user device 142 or a user of one of the approved devices 150.

In operation 413, the computing device 102 generates a chronological timeline of the incident including the events leading up to the incident and the events following the incident. In some examples, generating the chronological timeline includes ordering the tagged pre-incident events and the tagged post-incident events by time. In some examples, the events are ordered from oldest to newest, i.e., the earliest event is listed first and the most recent event is listed last. In some examples, the events are ordered from newest to oldest, i.e., the most recent event is listed first and the earliest event is listed last. As discussed herein, the generated timeline is used to generate the report that is output to one or more devices.

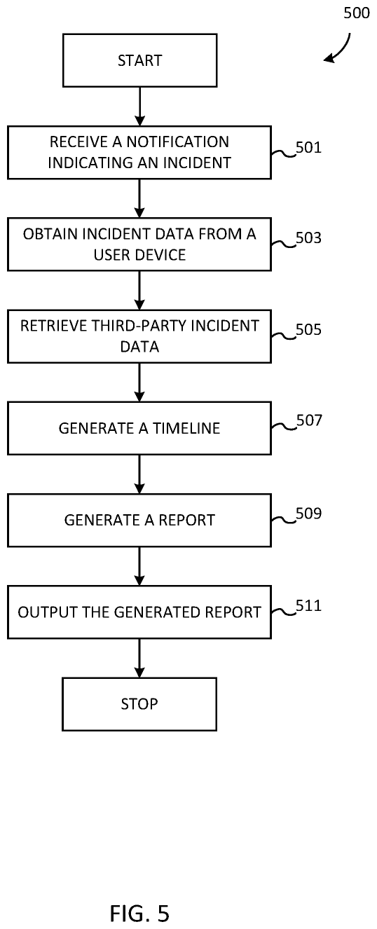

FIG. 5 is a flowchart illustrating a computer-implemented method of generating a post-vehicular incident reconstruction report according to an example. The computer-implemented method 500 is presented for illustration only and should not be construed as limiting. Other examples of the computer-implemented method 500 can be used without departing from the scope of the present disclosure. The computer-implemented method 500 can be implemented by one or more electronic devices described herein, such as the computing device 102.

The method 500 begins by the computing device 102 receiving a notification indicating an incident in operation 501. The received notification is transmitted from a user device, such as the user device 142, involved in the incident.

In operation 503, the computing device 102 obtains incident data from the user device 142. The obtained incident data and includes, but is not limited to, one or more of a speed of the user device 142 prior to the incident, a speed of the user device 142 immediately following the incident, a speed limit at the location of the user device 142, a status of a user of the user device 142 after the incident, a usage state of the user device 142 prior to the incident, a history of the trip that includes the incident, weather data for the trip that includes the incident, the input from the user to the user device 142 following the incident, and so forth.

Responsive to obtaining the incident data from the user device 142, the computing device 102 identifies a unique identifier corresponding to the user device 142. As described herein, the unique identifier is a phone number corresponding the user device 142, a serial number of the user device 142, and so forth. Using the unique identifier, the computing device 102 confirms the user device 142 is opted in to a report generation feature. Responsive to the confirmation, the retrieval of the third-party incident data is triggered.

In operation 505, the computing device 102 retrieves the third-party incident data that corresponds to the timestamp and the location data received in the obtained incident data. To retrieve the third-party incident data, the computing device 102 transmits a request, to a third-party device such as the emergency response device 160, for the third-party incident data. The transmitted request includes the unique identifier corresponding to the user device 142, the timestamp in the obtained incident data, and the location data in the obtained incident data. The transmitted request is then authenticated by the emergency response device 160 and the emergency response device 160 transmits the third-party incident data. Responsive to the third-party device authenticating the request, the computing device 102 receives the transmitted third-party incident data from the third-party device.

In some examples, the method further comprises analyzing the obtained incident data from the user device 142 and the retrieved third-party incident data to determine a severity of the incident. Responsive to the determined severity of the incident being determined to be above a threshold, the computing device 102 triggers the generation of the report of the incident.

In operation 507, the computing device 102 generates a timeline of the incident based on the obtained incident data from the user device and the retrieved third-party incident data. The generated timeline including events occurring prior to the incident and events occurring after the incident. To generate the timeline of the incident, the computing device 102 identifies one or more pre-incident events in the obtained incident data from the user device 142, tags the identified one or more pre-incident events with a timestamp, identifies one or more post-incident events in the retrieved third-party incident data, tags the identified one or more post-incident events with a timestamp, converts the tagged one or more pre-incident events and the tagged one or more post-incident events into a textual format including the respective timestamps, and generates the timeline of the incident that includes a chronological ordering of the textual format of the converted pre-incident events and the textual format of the converted post-incident events.

In operation 509, the computing device 102 generates a report of the incident based on the generated timeline, the obtained incident data, and the retrieved third-party incident data, the report including the timeline. In operation 511, the computing device 102 outputs the generated report to the user device 142 and at least one of the plurality of approved devices 150.

Additional aspects and examples disclosed herein are directed to a system, method and/or one or more computer storage devices having computer-executable instructions stored thereon for generating a post-vehicular incident report as illustrated in FIG. 5.

Alternatively, or in addition to the other examples described herein, examples include any combination of the following:
receiving a notification from a user device indicating the user device has been involved in an incident;
responsive to receiving the notification from the user device, obtaining incident data from the user device, the incident data including a timestamp and location data;
responsive to obtaining the incident data, retrieving third-party incident data corresponding to the timestamp and the location data received in the incident data;
generating a timeline of the incident based on the obtained incident data from the user device and the retrieved third-party incident data, the generated timeline including events occurring prior to the incident and events occurring after the incident;
generating a report of the incident based on the generated timeline, the obtained incident data, and the retrieved third-party incident data, the report including the timeline;
outputting the generated report to the user device and at least one of a plurality of approved devices;
analyzing the obtained incident data from the user device and the retrieved third-party incident data to determine a severity of the incident;
responsive to the determined severity of the incident being determined to be above a threshold, triggering the generation of the report of the incident;
responsive to obtaining the incident data from the user device, identifying a unique identifier corresponding to the user device;
using the unique identifier, confirming the user device is opted in to a report generation feature;
responsive to the confirmation, triggering the retrieval of the third-party incident data;
transmitting a request, to a third-party device, for the third-party incident data, wherein the request includes the unique identifier corresponding to the user device, the timestamp in the incident data, and the location data in the incident data;
responsive to the third-party device authenticating the request, receiving the third-party incident data from the third-party device;
identifying one or more pre-incident events in the obtained incident data from the user device;
tagging the identified one or more pre-incident events with a timestamp;
identifying one or more post-incident events in the retrieved third-party incident data;
tagging the identified one or more post-incident events with a timestamp;
converting the tagged one or more pre-incident events and the tagged one or more post-incident events into a textual format including the respective timestamps;
generating the timeline of the incident, the timeline including a chronological ordering of the textual format of the converted pre-incident events and the textual format of the converted post-incident events;
the plurality of approved devices comprise approved devices within an account;
the obtained incident data from the user device further includes at least one a speed of the user device prior to the incident, a speed of the user device immediately following the incident, a speed limit at the location of the user device, a status of a user of the user device after the incident, or a usage state of the user device prior to the incident; and
the retrieved third-party incident data includes at least one of whether an emergency response was initiated, whether air bags were deployed in a vehicle involved in the incident, a route emergency responders took to the location of the incident, a time at which the emergency responders arrived at the location of the incident, or details from an emergency response call.

### Exemplary Operating Environment

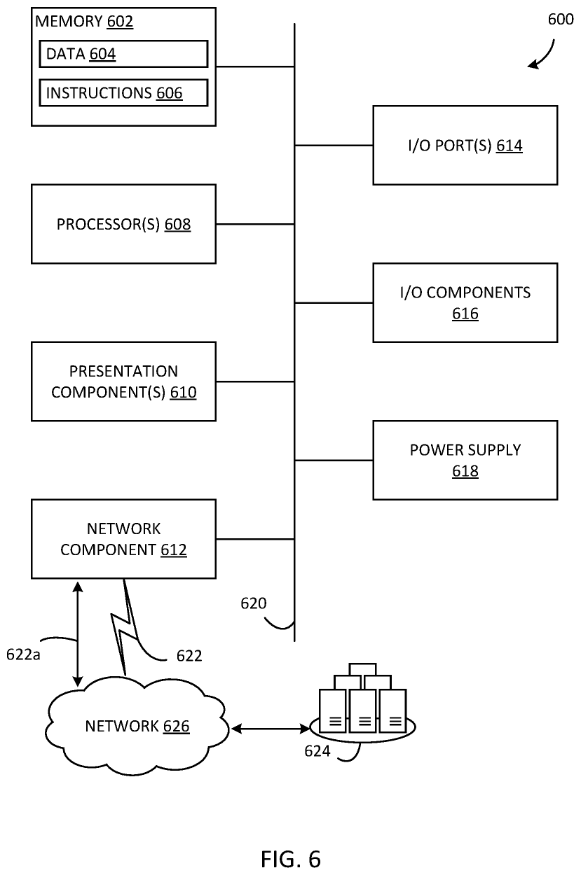

FIG. 6 is a block diagram of an example computing device 600 for implementing aspects disclosed herein and is designated generally as computing device 600. Computing device 600 is an example of a suitable computing environment and is not intended to suggest any limitation as to the scope of use or functionality of the examples disclosed herein. Neither should computing device 600 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 600 includes a bus 620 that directly or indirectly couples the following devices: computer-storage memory 602, one or more processors 608, one or more presentation components 610, I/O ports 614, I/O components 616, a power supply 618, and a network component 612. While computing device 600 is depicted as a seemingly single device, multiple computing devices 600 may work together and share the depicted device resources. For example, memory 602 may be distributed across multiple devices, and processor(s) 608 may be housed with different devices.

Bus 620 represents what may be one or more busses (such as an address bus, data bus, or a combination thereof). Although the various blocks of FIG. 6 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 6 and the references herein to a “computing device.” Memory 602 may take the form of the computer-storage media references below and operatively provide storage of computer-readable instructions, data structures, program modules and other data for computing device 600. In some examples, memory 602 stores one or more of an operating system, a universal application platform, or other program modules and program data. Memory 602 is thus able to store and access data 604 and instructions 606 that are executable by processor 608 and configured to carry out the various operations disclosed herein.

In some examples, memory 602 includes computer-storage media in the form of volatile and/or nonvolatile memory, removable or non-removable memory, data disks in virtual environments, or a combination thereof. Memory 602 may include any quantity of memory associated with or accessible by computing device 600. Memory 602 may be internal to computing device 600 (as shown in FIG. 6), external to computing device 600, or both. Examples of memory 602 in include, without limitation, random access memory (RAM); read only memory (ROM); electronically erasable programmable read only memory (EEPROM); flash memory or other memory technologies; CD-ROM, digital versatile disks (DVDs) or other optical or holographic media; magnetic cassettes, magnetic tape, magnetic disk storage or other magnetic storage devices; memory wired into an analog computing device; or any other medium for encoding desired information and for access by computing device 600. Additionally, or alternatively, memory 602 may be distributed across multiple computing devices 600, for example, in a virtualized environment in which instruction processing is carried out on multiple computing devices 600. For the purposes of this disclosure, “computer storage media,” “computer-storage memory,” “memory,” and “memory devices” are synonymous terms for computer-storage memory 602, and none of these terms include carrier waves or propagating signaling.

Processor(s) 608 may include any quantity of processing units that read data from various entities, such as memory 602 or I/O components 616 and may include CPUs and/or GPUs. Specifically, processor(s) 608 are programmed to execute computer-executable instructions for implementing aspects of the disclosure. The instructions may be performed by the processor, by multiple processors within computing device 600, or by a processor external to client computing device 600. In some examples, processor(s) 608 are programmed to execute instructions such as those illustrated in the in the accompanying drawings. Moreover, in some examples, processor(s) 608 represent an implementation of analog techniques to perform the operations described herein. For example, the operations may be performed by an analog client computing device 600 and/or a digital client computing device 600. Presentation component(s) 610 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 600, across a wired connection, or in other ways. I/O ports 614 allow computing device 600 to be logically coupled to other devices including I/O components 616, some of which may be built in. Example I/O components 616 include, for example but without limitation, a microphone, joystick, game pad, satellite dish, scanner, printer, wireless device, etc.

Computing device 600 may operate in a networked environment via network component 612 using logical connections to one or more remote computers. In some examples, network component 612 includes a network interface card and/or computer-executable instructions (e.g., a driver) for operating the network interface card. Communication between computing device 600 and other devices may occur using any protocol or mechanism over any wired or wireless connection. In some examples, network component 612 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 612 communicates over wireless communication link 622 and/or a wired communication link 622a to a cloud resource 624 across network 626. Various different examples of communication links 622 and 622a include a wireless connection, a wired connection, and/or a dedicated link, and in some examples, at least a portion is routed through the internet.

Although described in connection with an example computing device 600, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality (MR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

What is claimed is:

1. A system for generating a post-vehicular incident report, the system comprising:
a processor; and
a computer-readable medium storing instructions that are operative, upon execution by the processor, to cause the processor to:
receive a notification from a user device indicating the user device has been involved in an incident,
responsive to receiving the notification from the user device, obtain incident data from the user device, the incident data including a timestamp and location data,
responsive to obtaining the incident data, retrieve third-party incident data corresponding to the timestamp and the location data received in the incident data,
generate a timeline of the incident based on the obtained incident data from the user device and the retrieved third-party incident data, the generated timeline including events occurring prior to the incident and events occurring after the incident,
generate a report of the incident based on the generated timeline, the obtained incident data, and the retrieved third-party incident data, the report including the timeline, and
output the generated report to the user device and at least one of a plurality of approved devices.

2. The system of claim 1, wherein the computer-readable medium further stores instructions that are operative, upon execution by the processor, to cause the processor to:
analyze the obtained incident data from the user device and the retrieved third-party incident data to determine a severity of the incident.

3. The system of claim 2, wherein the computer-readable medium further stores instructions that are operative, upon execution by the processor, to cause the processor to, responsive to the determined severity of the incident being determined to be above a threshold, trigger the generation of the report of the incident.

4. The system of claim 1, wherein the computer-readable medium further stores instructions that are operative, upon execution by the processor, to cause the processor to:
responsive to obtaining the incident data from the user device, identify a unique identifier corresponding to the user device,
using the unique identifier, confirm the user device is opted in to a report generation feature, and
responsive to the confirmation, trigger the retrieval of the third-party incident data.

5. The system of claim 4, wherein, to retrieve the third-party incident data, the computer-readable medium further stores instructions that are operative, upon execution by the processor, to cause the processor to:
transmit a request, to a third-party device, for the third-party incident data, wherein the request includes the unique identifier corresponding to the user device, the timestamp in the incident data, and the location data in the incident data, and
responsive to the third-party device authenticating the request, receive the third-party incident data from the third-party device.

6. The system of claim 1, wherein, to generate the timeline of the incident, the computer-readable medium further stores instructions that are operative, upon execution by the processor, to cause the processor to:
identify one or more pre-incident events in the obtained incident data from the user device,
tag the identified one or more pre-incident events with a timestamp,
identify one or more post-incident events in the retrieved third-party incident data,
tag the identified one or more post-incident events with a timestamp,
convert the tagged one or more pre-incident events and the tagged one or more post-incident events into a textual format including the respective timestamps, and
generate the timeline of the incident, the timeline including a chronological ordering of the textual format of the converted pre-incident events and the textual format of the converted post-incident events.

7. The system of claim 1, wherein the plurality of approved devices comprise approved devices within an account.

8. The system of claim 1, wherein:
the obtained incident data from the user device further includes at least one a speed of the user device prior to the incident, a speed of the user device immediately following the incident, a speed limit at the location of the user device, a status of a user of the user device after the incident, or a usage state of the user device prior to the incident, and
the retrieved third-party incident data includes at least one of whether an emergency response was initiated, whether air bags were deployed in a vehicle involved in the incident, a route emergency responders took to the location of the incident, a time at which the emergency responders arrived at the location of the incident, or details from an emergency response call.

9. A computer-implemented method comprising:
receiving a notification from a user device indicating the user device has been involved in an incident,
responsive to receiving the notification from the user device, obtaining incident data from the user device, the incident data including a timestamp and location data,
responsive to obtaining the incident data, retrieving third-party incident data corresponding to the timestamp and the location data received in the incident data,
generating a timeline of the incident based on the obtained incident data from the user device and the retrieved third-party incident data, the generated timeline including events occurring prior to the incident and events occurring after the incident,
generating a report of the incident based on the generated timeline, the obtained incident data, and the retrieved third-party incident data, the report including the timeline, and
outputting the generated report to the user device and at least one of a plurality of approved devices.

10. The computer-implemented method of claim 9, further comprising analyzing the obtained incident data from the user device and the retrieved third-party incident data to determine a severity of the incident.

11. The computer-implemented method of claim 10, further comprising, responsive to the determined severity of the incident being determined to be above a threshold, triggering the generation of the report of the incident.

12. The computer-implemented method of claim 9, further comprising:
responsive to obtaining the incident data from the user device, identifying a unique identifier corresponding to the user device,
using the unique identifier, confirming the user device is opted in to a report generation feature, and
responsive to the confirmation, triggering the retrieval of the third-party incident data.

13. The computer-implemented method of claim 12, wherein retrieving the third-party incident data comprises:
transmitting a request, to a third-party device, for the third-party incident data, wherein the request includes the unique identifier corresponding to the user device, the timestamp in the incident data, and the location data in the incident data, and
responsive to the third-party device authenticating the request, receiving the third-party incident data from the third-party device.

14. The computer-implemented method of claim 9, wherein generating the timeline of the incident comprises:
identifying one or more pre-incident events in the obtained incident data from the user device,
tagging the identified one or more pre-incident events with a timestamp,
identifying one or more post-incident events in the retrieved third-party incident data,
tagging the identified one or more post-incident events with a timestamp,
converting the tagged one or more pre-incident events and the tagged one or more post-incident events into a textual format including the respective timestamps, and
generating the timeline of the incident, the timeline including a chronological ordering of the textual format of the converted pre-incident events and the textual format of the converted post-incident events.

15. The computer-implemented method of claim 9, wherein the plurality of approved devices comprise approved devices within an account.

16. The computer-implemented method of claim 9, wherein:
the obtained incident data from the user device further includes at least one a speed of the user device prior to the incident, a speed of the user device immediately following the incident, a speed limit at the location of the user device, a status of a user of the user device after the incident, or a usage state of the user device prior to the incident, and
the retrieved third-party incident data includes at least one of whether an emergency response was initiated, whether air bags were deployed in a vehicle involved in the incident, a route emergency responders took to the location of the incident, a time at which the emergency responders arrived at the location of the incident, or details from an emergency response call.

17. One or more computer-readable storage media for generating a post-vehicular incident report comprising a plurality of instructions that, when executed by a processor, cause the processor to:
receive a notification from a user device indicating the user device has been involved in an incident,
responsive to receiving the notification from the user device, obtain incident data from the user device, the incident data including a timestamp and location data,
responsive to obtaining the incident data, retrieve third-party incident data corresponding to the timestamp and the location data received in the incident data,
generate a timeline of the incident based on the obtained incident data from the user device and the retrieved third-party incident data, the generated timeline including events occurring prior to the incident and events occurring after the incident,
generate a report of the incident based on the generated timeline, the obtained incident data, and the retrieved third-party incident data, the report including the timeline, and
output the generated report to the user device and at least one of a plurality of approved devices.

18. The one or more computer-readable storage media of claim 17, further comprising a plurality of instructions that, when executed by a processor, further cause the processor to:
analyze the obtained incident data from the user device and the retrieved third-party incident data to determine a severity of the incident, and
responsive to the determined severity of the incident being determined to be above a threshold, trigger the generation of the report of the incident.

19. The one or more computer-readable storage media of claim 17, further comprising a plurality of instructions that, when executed by a processor, further cause the processor to:
responsive to obtaining the incident data from the user device, identify a unique identifier corresponding to the user device,
using the unique identifier, confirm the user device is opted in to a report generation feature,
responsive to the confirmation, transmit a request, to a third-party device, for the third-party incident data, wherein the request includes the unique identifier corresponding to the user device, the timestamp in the incident data, and the location data in the incident data, and
responsive to the third-party device authenticating the request, receive the third-party incident data from the third-party device.

20. The one or more computer-readable storage media of claim 17, further comprising a plurality of instructions that, when executed by a processor, further cause the processor, to generate the timeline of the incident, to:
identify one or more pre-incident events in the obtained incident data from the user device,
tag the identified one or more pre-incident events with a time stamp,
identify one or more post-incident events in the retrieved third-party incident data,
tag the identified one or more post-incident events with a time stamp,
convert the tagged one or more pre-incident events and the tagged one or more post-incident events into a textual format including the respective time stamps, and
generate the timeline of the incident, the timeline including a chronological ordering of the textual format of the converted pre-incident events and the textual format of the converted post-incident events.
